(19) United States
(12) Patent Application Publication
(10) Pub. No.: US 2006/0284503 A1
(43) Pub. Date: Dec. 21, 2006

(54) OIL RETAINING AND LUBRICATING STRUCTURE OF A FAN

(75) Inventors: Shih-Jen Lin, Taipei (TW); Fu-Yin Chuang, Hsichih City, Taipei Hsien (TW)

Correspondence Address: GLOBAL WIN TECHNOLOGY CO., LTD., P.O. BOX 108-00403, TAIPEI 106, TW

(73) Assignee: GLOBAL WIN TECHNOLOGY CO., LTD., Taipei (TW)

(21) Appl. No.: 11/420,484

(22) Filed: May 26, 2006

(30) Foreign Application Priority Data
Jun. 15, 2005 (TW) 094210027

(51) Int. Cl. H02K 7/00; H02K 5/16; F16C 33/02; F04B 17/00

(52) U.S. Cl. 310/90; 310/67 R; 417/423.12; 384/279; 384/411

(57) ABSTRACT

An oil retaining and lubricating structure of an electric fan is disclosed to include a hub having a center barrel and a receiving chamber defined in the center barrel, a shaft rotatably mounted in the center barrel of the hub, an axle bearing mounted in the receiving chamber to support the shaft in the center barrel, and an elastic porous oil retainer mounted in the receiving chamber around the shaft and retaining lubricating oil for lubricating the shaft and the axle bearing upon rotation of the shaft with a fan blade assembly relative to the hub.

This application claims the priority benefit of Taiwan patent application number 094210027 filed on Jun. 15, 2005.

### BACKGROUND OF THE INVENTION

1. Field of the Invention

The present invention relates to an electric fan and more specifically, to an oil retaining and lubricating structure of an electric fan, which retains lubricating oil for lubricating the shaft and the axle bearings of the electric fan upon rotation of the shaft with the fan blade assembly, thereby prolonging the work life of the electric fan.

2. Description of the Related Art

Following fast development of computer technology, high-speed CPUs (Central Processing Units) have been continuously created. These high-speed CPUs produce much heat during operation. In order to maintain normal operation of a CPU, heat must be quickly carried away from the CPU. Various cooling fans have been developed for this purpose. A cooling fan uses axle bearings to support the shaft so that the shaft can be rotated with the fan blade assembly at a high speed. The use of axle bearings in a cooling fan is adapted to achieve the objects of prolonging the work life of the electric fan and reducing the noise level and loss of power of the electric fan. In order to achieve these objects, the axle bearing and the shaft of a cooling fan must be well lubricated to lower the friction. Therefore, the gap between the axle bearing and the shaft in a cooling fan is generally filled with lubricating oil. FIG. 5 shows the lubricating structure of a conventional cooling fan. As illustrated in FIG. 5, the fan shaft A has oil guide grooves A1 on the periphery, and is supported on an axle bearing B in a center hole C1 of a socket C. During rotation of the fan shaft A, the oil guide grooves A1 suck lubricating oil from an oil trough C2 to lubricate the axle bearing B. This lubricating structure has numerous drawbacks as outlined hereinafter:
1. The oil trough C2 is formed in the socket C at the bottom side. When the cooling fan is kept in vertical, lubricating oil is accumulated in the oil trough C2. At this time, the centrifugal force that is produced during rotation of the fan shaft A is insufficient to draw lubricating oil upwards from the oil trough C2 to the gap between the fan shaft A and the axle bearing B.
2. Because the oil trough C2 is provided at the bottom side inside the socket C and the oil guide grooves A1 of the fan shaft A are disposed in the center area of the axle bearing B, the oil guide grooves A1 cannot effectively guide lubricating oil upwards from the oil trough C2 to the gap between the axle bearing B and the fan shaft A during rotation of the fan shaft A.
3. The top side of the socket C is an open side. When the cooling fan is placed in horizontal during packing, delivery or an use, lubricating oil may flow from the oil trough C2 through the gap between the fan shaft A and the axle bearing B to the outside of the socket C. During operation of the cooling fan, lubricating oil may also be forced out of the socket C by the produced centrifugal force. Further, external dust and impurities may fall to the inside of the socket C to contaminate lubricating oil, and oil dirt may be accumulated in the gap between the fan shaft A and the axle bearing B, thereby increasing friction between the fan shaft A and the axle bearing B during rotation of the fan shaft A and shortening the work life of the cooling fan.

### SUMMARY OF THE INVENTION

The present invention has been accomplished under the circumstances in view. According to one aspect of the present invention, the oil retaining and lubricating structure is used in an electric fan, comprising a hub, which has a center barrel and a receiving chamber defined in the center barrel, a shaft, which is rotatably mounted in the center barrel of the hub, an axle bearing, which is mounted in the receiving chamber to support the shaft in the center barrel, and an elastic porous oil retainer, which is mounted in the receiving chamber around the shaft and retains lubricating oil for lubricating the shaft and the axle bearing upon rotation of the shaft with a fan blade assembly relative to the hub. According to another aspect of the present invention, the hub further comprises a top cover and a bottom cover respectively covered on the top side and bottom side of the center barrel, an oil-spreading space defined between the top cover and the axle bearing, and a plurality of flow guide ribs suspending in the oil-spreading space. During rotation of the shaft, a centrifugal force is produced, causing lubricating oil to be thrown away from the shaft into the oil-spreading space for guiding by the flow guide ribs toward the elastic porous oil retainer for further circulation. According to still another aspect of the present invention, longitudinal oil grooves are formed on the inside wall of the center barrel and the periphery of the axle bearing for guiding lubricating oil from the oil-spreading space to the elastic porous oil retainer for further circulation, and the elastic porous oil retainer effectively filtrates solid matters from lubricating oil.

### BRIEF DESCRIPTION OF THE DRAWINGS

FIG. 1 is an exploded view of an oil retaining and lubricating structure of an electric fan in accordance with a first embodiment of the present invention.

FIG. 2 is a cutaway view of the first embodiment of the present invention.

FIG. 3 is sectional side view of the first embodiment of the present invention.

FIG. 3A is an enlarged view of a part of FIG. 3.

FIG. 4 is sectional side view of an oil retaining and lubricating structure of an electric fan in accordance with a second embodiment of the present invention.

FIG. 4A is an enlarged view of a part of FIG. 4.

FIG. 5 is a sectional side view of the lubricating structure of a conventional cooling fan.

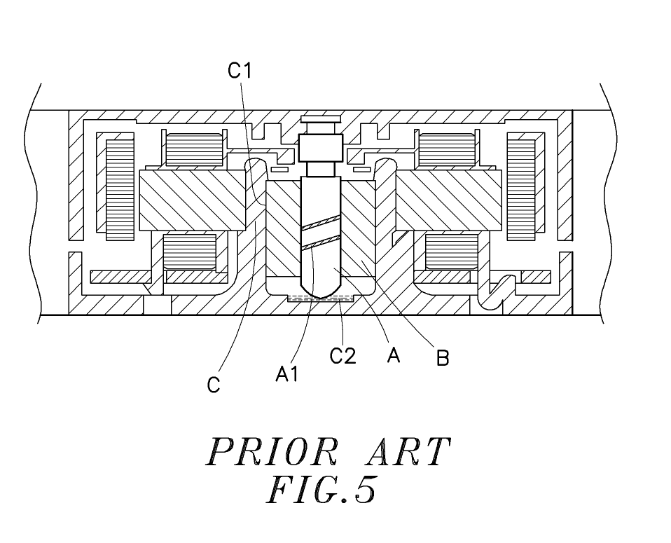

### DETAILED DESCRIPTION OF THE PREFERRED EMBODIMENT

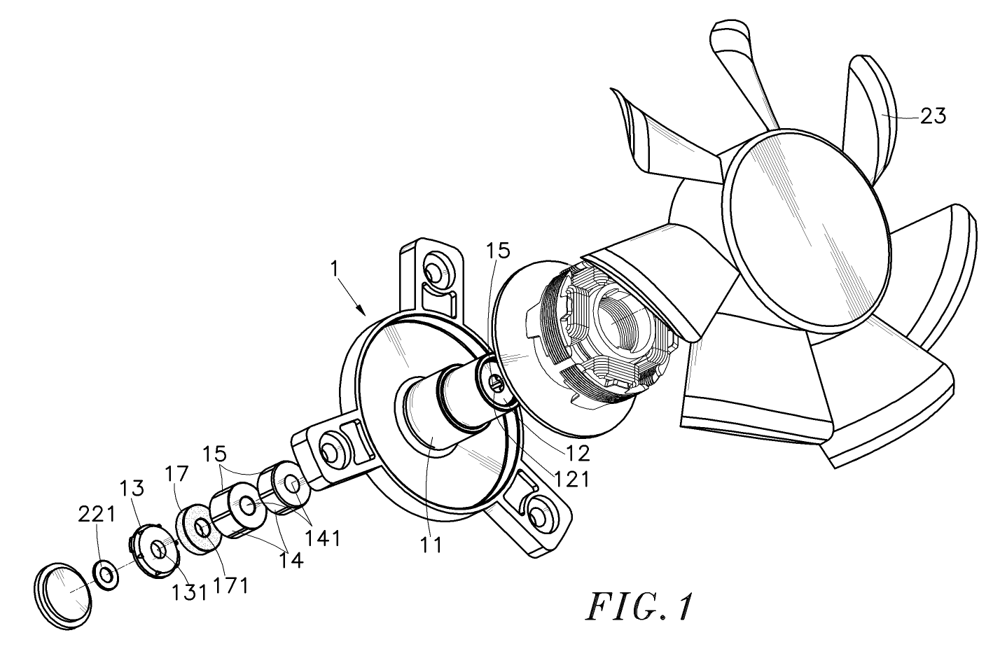

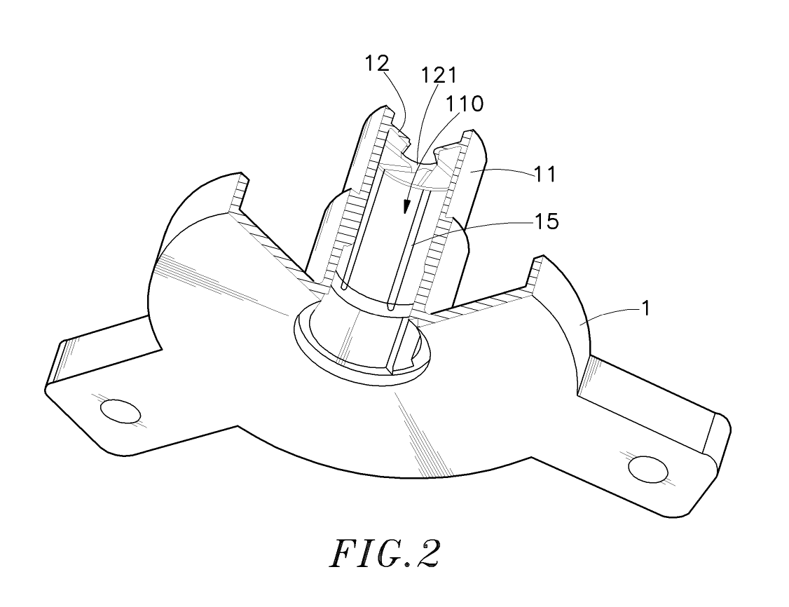

Referring to FIGS. 1, 2, 3 and 3A, an oil retaining and lubricating structure of an electric fan in accordance with the present invention is shown comprised of a hub 1 and a shaft 2.

The hub 1 has an axially extending center barrel 11, which defines a receiving chamber 110, a top cover 12, which is covered on the top side of the receiving chamber 110 and has a center through hole 121 in communication with the receiving chamber 110, and a bottom cover 13, which is covered on the bottom side of the receiving chamber 110 and has a center through hole 131 in communication with the receiving chamber 110. Two axle bearings 14 are arranged in a stack inside the receiving chamber 110, defining with the bottom wall of the top cover 12 an oil-spreading space 16. The axle bearings 14 each have a center axle hole 141 disposed in line with the center through hole 121 of the top cover 12 and the center through hole 131 of the bottom cover 13. Further, longitudinal oil grooves 15 are formed between the axle bearings 14 and the center barrel 11 of the hub 1. Flow guide ribs 161 are formed integral with the bottom wall of the top cover 12 and suspending in the oil-spreading space 16. An elastic porous oil retainer 17 is mounted in the receiving chamber 110 between the bottom side of the axle bearings 14 and the top wall of the bottom cover 13. The elastic porous oil retainer 17 has a through hole 171 in line with the center axle holes 141 of the axle bearings 14 and the center through hole 131 of the bottom cover 13.

The shaft 2 is mounted in the receiving chamber 110 of the center barrel 11 of the hub 1, having guide grooves 21 formed on the periphery and disposed between the axle bearings 14 and the elastic porous oil retainer 17 and a locating groove 22 extending around the periphery near one end, namely, the bottom end thereof. A retaining ring 221 is fastened to the locating groove 22 of the shaft 2 to secure the shaft 2 to the hub 1, allowing rotation of the shaft 2 relative to the hub 1. A fan blade assembly 23 is fixedly mounted on the other end, namely, the top end of the shaft 2 outside the center barrel 11 of the hub 1.

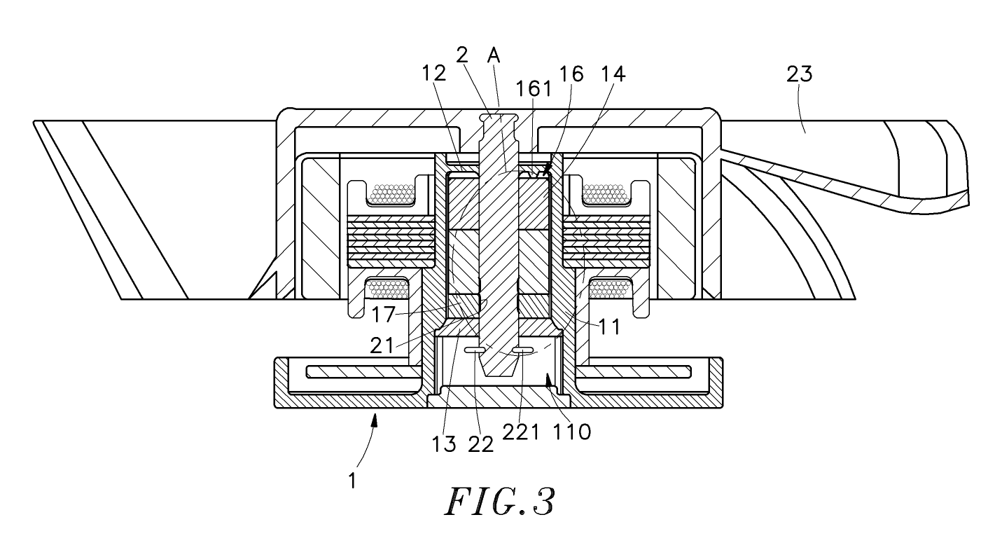

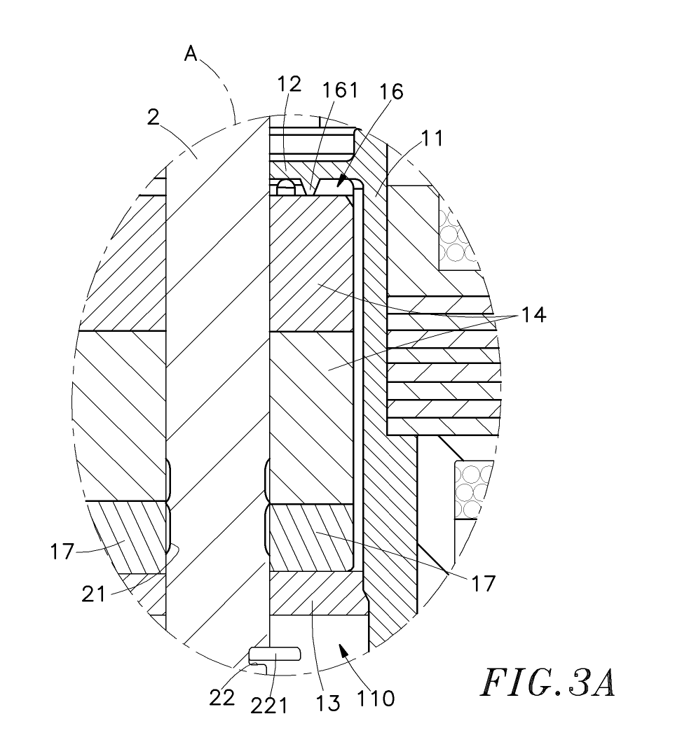

Referring to FIGS. 3 and 3A again, during assembly process of the present invention, the axle bearings 14 and the elastic porous oil retainer 17 are inserted in proper order into the receiving chamber 110 of the center barrel 11, and then the shaft 2 is inserted in proper order through the center through hole 121 of the top cover 12, the center axle holes 141 of the axle bearings 14, the through hole 171 of the elastic porous oil retainer 17 and the center through hole 131 of the bottom cover 13, and then the retaining ring 221 is fastened to the locating groove 22 of the shaft 2 to secure the shaft 2 in place. After installation of the present invention, lubricating oil is filled in the receiving chamber 110 of the center barrel 11 of the hub 1, for enabling the elastic porous oil retainer 17 to absorb lubricating oil. During rotation of the shaft 2 with the fan blade assembly 23, the elastic porous oil retainer 17 releases lubricating oil gradually. At this time, the capillary structure of the guide grooves 21 of the shaft 2 causes a siphon action to absorb lubricating oil from the elastic porous oil retainer 17 to the guide groove 21 for lubricating the shaft 2 and the axle bearings 14 and also to guide absorbed lubricating oil toward the top side for enabling lubricating oil to be further thrown away from the shaft 2 by the centrifugal force produced during rotation of the shaft 2 into the oil-spreading space 16 and guided by the flow guide ribs 161 to the longitudinal oil grooves 15 between the center barrel 11 and the axle bearing 14 and then returned to the elastic porous oil retainer 17 for further circulation. Therefore, lubricating oil is continuously circulated in the receiving chamber 110 inside the center barrel 11 of the hub 1 to lubricate the related parts. Further, the elastic porous oil retainer 17 can be made out of sponge or the like that effectively absorbs lubricating oil and filtrate solid matters from lubricating oil, keeping lubricating oil clean for lubricating the shaft 2 and the axle bearings 14.

Further, solidified oil may be filled in gaps between the center through holes 121 and 131 of the top and bottom covers 12 and 13 and the periphery of the shaft 2. Thus, lubricating oil is prohibited from flowing out of the receiving chamber 110 and outside dust and other solid matters are prohibited from entering the receiving chamber 110 when the hub 1 is placed in horizontal or turned upside down. Therefore, lubricating oil in the receiving chamber 110 is constantly kept clean for lubrication.

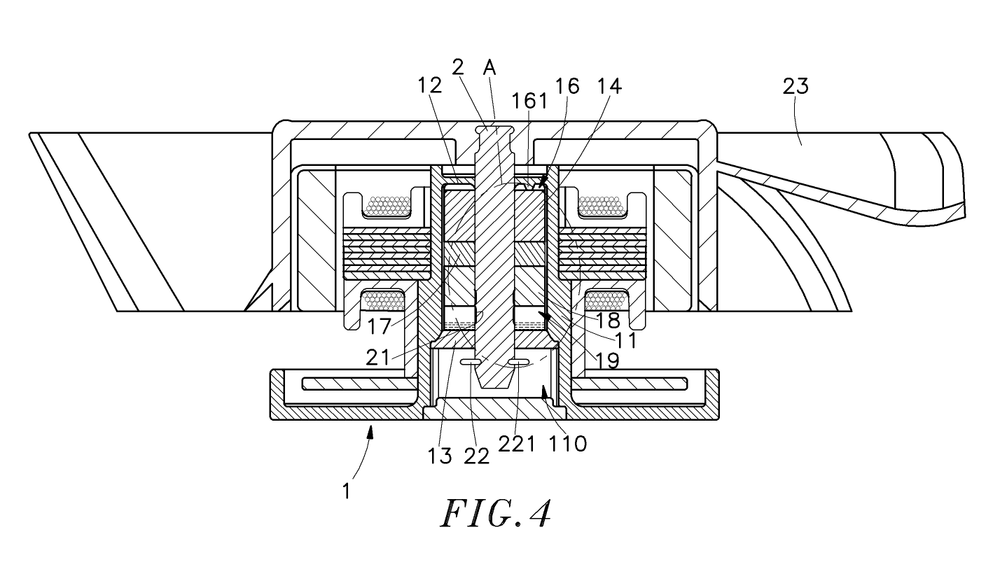

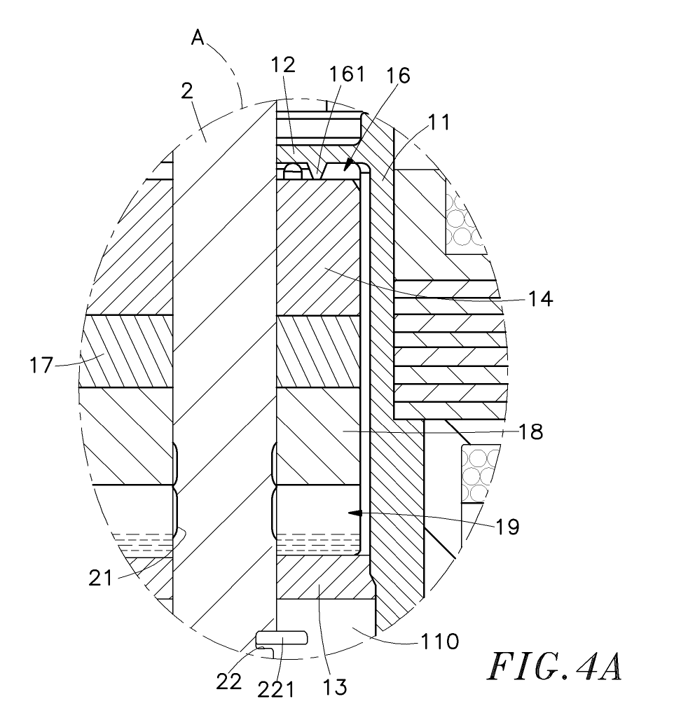

FIGS. 4 and 4A show an alternate form of the present invention. According to this embodiment, a second axle bearing 18 is mounted in the receiving chamber 110 around the shaft 2 between the elastic porous oil retainer 17 and the bottom cover 13; an oil accumulation space 19 is defined in the receiving chamber 110 between the bottom side of the second axle bearing 18 and the top side of the bottom cover 13; the guide grooves 21 of the shaft 2 are kept between the second axle bearing 18 and the oil accumulation space 19. During rotation of the shaft 2 in the hub 1, the guide grooves 21 of the shaft 2 guide lubricating oil upwards from the oil accumulation space 19 through the elastic porous oil retainer 17 toward the oil-spreading space 16, and the elastic porous oil retainer 17 filtrates solid matters from lubricating oil. This design increases accumulation of lubricating oil in the barrel 11 of the hub 1. Further, the second axle bearing 18 stabilizes rotation of the shaft 2 in the hub 1, preventing vibration. The arrangement and design of the elastic porous oil retainer 17 may be changed subject to different requirements.

As indicated above, the oil retaining and lubricating structure of the present invention has the following benefits:

1. During rotation of the shaft 2, a centrifugal force is produced, causing the elastic porous oil retainer 17 to release absorbed lubricating oil gradually for lubricating the shaft 2 and the axle bearings 14, therefore the shaft 2 and the axle bearings 14 are constantly lubricated during operation of the electric fan and the work life of the electric fan is greatly prolonged.

2. The elastic porous oil retainer 17 absorbs and retains lubricating oil, preventing flow of lubricating oil out of the hub 1 through the center through hole 121 of the top cover 12 when the hub 1 is placed in horizontal or turned upside down.

3. The guide grooves 21 of the shaft 2 are disposed between the through hole 171 of the elastic porous oil retainer 17 and the center axle holes 141 of the axle bearings 14 so that the siphon action of the capillary structure of the guide grooves 21 of the shaft 2 sucks lubricating oil into the gaps between the shaft 2 and the axle bearings 14 to lubricate the shaft 2 and the axle bearings 14.

4. The centrifugal force produced during rotation of the shaft 2 causes lubricating oil to be thrown away from the shaft 2 into the oil-spreading space 16 and then guided by the flow guide ribs 161 to the longitudinal oil grooves 15 and then returned to the elastic porous oil retainer 17 for further circulation.

5. Further, solidified oil can be filled in gaps between the center through holes 121 and 131 of the top and bottom covers 12 and 13 and the periphery of the shaft 2, so that lubricating oil is stopped from flowing out of the receiving chamber 110 of the hub 1 and outside dust and solid matters are prohibited from entering the receiving chamber 110 of the hub 1 when the hub 1 is placed in horizontal or turned upside down. Therefore, the shaft 2 and the axle bearings 14 are constantly lubricated, preventing vibration of the shaft 2 during operation of the electric fan and contamination of lubricating oil with dust.

A prototype of an oil retaining and lubricating structure of an electric fan has been constructed with the features of FIGS. 1˜4. The oil retaining and lubricating structure of an electric fan functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An oil retaining and lubricating structure comprising:
a hub, said hub having an axially extending center barrel, said center barrel defining a receiving chamber;
a shaft inserted through said center barrel of said hub and rotatable relative to said hub;
at least one first axle bearing mounted in said receiving chamber of said center barrel around said shaft to support said shaft in said center barrel, said at least one first axle bearing each having a center axle hole for the passing of said shaft; and
an elastic porous oil retainer mounted in said receiving chamber inside said center barrel around said shaft and adapted to retain lubricating oil for lubricating said shaft and said at least one first axle bearing upon rotation of said shaft relative to said center barrel.

2. The oil retaining and lubricating structure as claimed in claim 1, wherein a plurality of longitudinal oil grooves are formed between said center barrel and said at least one first axle bearing.

3. The oil retaining and lubricating structure as claimed in claim 1, further comprising a top cover and a bottom cover respectively covered on top and bottom sides of said receiving chamber of said center barrel, said top cover and said bottom cover each having a center through hole for the passing of said shaft, said top cover defining with said at least one first axle bearing an oil-spreading space in said receiving chamber.

4. The oil retaining and lubricating structure as claimed in claim 3, further comprising a plurality of flow guide ribs suspending in said oil-spreading space.

5. The oil retaining and lubricating structure as claimed in claim 3, wherein said top cover is formed integral with a top side of said center barrel.

6. The oil retaining and lubricating structure as claimed in claim 3, wherein said bottom cover is formed integral with a bottom side of said center barrel.

7. The oil retaining and lubricating structure as claimed in claim 3, further comprising solidified oil filled up gaps between the center through holes of said top and bottom covers and the periphery of said shaft.

8. The oil retaining and lubricating structure as claimed in claim 1, wherein said shaft has at least one guide groove on the periphery thereof between said at least one axle bearing and said elastic porous oil retainer.

9. The oil retaining and lubricating structure as claimed in claim 1, wherein said shaft has a top end extending out of a top side of said receiving chamber of said center barrel and mounted with a fan blade assembly and a bottom end extending out of a bottom side of said receiving chamber of said center barrel, said bottom end of said shaft having a locating groove extending around the periphery thereof and a retaining ring fastened to said locating groove to secure said shaft to said center barrel.

10. The oil retaining and lubricating structure as claimed in claim 1, wherein said elastic porous oil retainer is made out of sponge.

11. The oil retaining and lubricating structure as claimed in claim 1, further comprising at least one second axle bearing mounted in said receiving chamber inside said center barrel around said shaft below said elastic porous oil retainer to support said shaft in said center barrel.
